(19) United States
(12) Patent Application Publication
(10) Pub. No.: US 2025/0063032 A1
(43) Pub. Date: Feb. 20, 2025

(54) SECURITY NETWORK SELECTION BETWEEN NETWORKS

(71) Applicant: ZTE CORPORATION, Shenzhen (CN)

(72) Inventors: Zhen XING, Shenzhen (CN); Shilin YOU, Shenzhen (CN); Yuze LIU, Shenzhen (CN); Zhaoji LIN, Shenzhen (CN)

(21) Appl. No.: 18/819,443

(22) Filed: Aug. 29, 2024

Related U.S. Application Data
(63) Continuation of application No. PCT/CN2022/098456, filed on Jun. 13, 2022.

(51) Int. Cl. H04L 9/40; H04L 65/1066

(52) U.S. Cl. CPC H04L 63/08; H04L 63/10; H04L 65/1066

(57) ABSTRACT

A wireless communication method is provided. The wireless communication method includes: receiving an authentication indicator; utilizing the authentication indicator to access authentication information; and providing the authentication information for selecting an authentication method.

### CROSS-REFERENCE TO RELATED APPLICATION(S)

This application is a continuation of International Patent Application No. PCT/CN2022/098456 filed on Jun. 13, 2022, and the entire content of the International Patent Application is incorporated into this application for reference.

### TECHNICAL FIELD

This document is directed generally to wireless communications. More specifically, a security mechanism is provided for selecting between different network types.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, improvements should be made to maintain and ensure the quality of service standards.

### SUMMARY

This document relates to methods, systems, and devices for selecting an authentication method for different networks. The authentication methods may include Transport Layer Security (TLS) that is determined between different types of networks, such as generations of networks, including Edge networks and New Radio (NR) networks. The authentication method may be selected based on authentication indicators or information regarding support of the methods of the networks. The authentication indicator or information may be transmitted during an establishment process.

In one embodiment, a wireless communication method that includes receiving an authentication indicator; utilizing the authentication indicator to access authentication information; and providing the authentication information for selecting an authentication method. The authentication indicator comprises an indication of an ability to receive the authentication information which comprises whether certain ones of a plurality of authentication methods are supported. The receiving the authentication indicator is during an establishment session. The providing is to a user equipment (UE) that determines the authentication method based on the provided authentication information. The authentication method is supported by Edge Configuration Server (ECS)/Edge Enabler Server (EES), further wherein the authentication information indicates the authentication method supported by ECS/EES that is used by the UE to determine authentication method support. A Session Management Function (SMF) receives the authentication information. A Session Management Function (SMF) has preconfigured the authentication information. The wireless communication method is for session establishment with local breakout and also in a non-roaming scenario. The wireless communication method is for session establishment with home routed roaming. The authentication indicator and the authentication information are transmitted between a visited network and a home network.

In another embodiment, a wireless communication method includes transmitting an authentication indicator, wherein the authentication indicator is used to access authentication information; receiving the authentication information; and selecting an authentication method based on the authentication information. The authentication indicator comprises an indication of an ability to receive the authentication information. The authentication information comprises whether certain ones of a plurality of authentication methods are supported. The transmitting, the receiving, and the selecting is by a user equipment (UE) and the accessing of the authentication information is by a network. The authentication method is supported by Edge Configuration Server (ECS)/Edge Enabler Server (EES), further wherein the authentication information indicates the authentication method supported by ECS/EES that is used by the UE to determine authentication method support. A Session Management Function (SMF) receives the authentication information. A Session Management Function (SMF) has preconfigured the authentication information. The wireless communication method is for session establishment with local breakout and also in a non-roaming scenario. The wireless communication method is for session establishment with home routed roaming. The method includes providing, from a user equipment (UE), a determination of the authentication method supported by the received authentication information; and returning a failure response when the authentication information indicates that the authentication method is not supported. The authentication indicator and the authentication information are transmitted between a visited network and a home network.

In another embodiment, a wireless communication method includes accessing authentication information comprising an indication of an ability to support edge computing services; and providing the authentication information for selecting an authentication method. The providing is to a user equipment (UE) that determines the authentication method based on the provided authentication information. The UE returns a failure response if the authentication information indicates that a particular authentication method is not supported. The authentication method is supported by Edge Configuration Server (ECS)/Edge Enabler Server (EES), further wherein the authentication information indicates the authentication method supported by ECS/EES that is used by the UE to determine authentication method support. A Session Management Function (SMF) receives the authentication information. A Session Management Function (SMF) has preconfigured the authentication information. The wireless communication method is for session establishment with local breakout and also in a non-roaming scenario. The wireless communication method is for session establishment with home routed roaming.

In another embodiment, a wireless communications apparatus comprising a processor and a memory, wherein the processor is configured to read code from the memory and implement any of the methods for wireless communication described herein.

In another embodiment, a computer program product comprising computer-readable program medium code stored thereupon, the code, when executed by a processor, causing the processor to implement any of the methods for wireless communication described herein.

### BRIEF DESCRIPTION OF THE DRAWINGS

FIG. 1 shows an example base station.

FIG. 2 shows an example random access (RA) messaging environment.

FIG. 3 shows an embodiment of a wireless network system architecture.

FIG. 4 shows an embodiment of a wireless network system architecture for enabling edge applications.

FIG. 5 shows an embodiment for security mechanism selection with local breakout.

FIG. 6 shows an embodiment for security mechanism selection for home-routed roaming.

FIG. 7 shows another embodiment for security mechanism selection with local breakout.

FIG. 8 shows another embodiment for security mechanism selection for home-routed roaming.

FIG. 9 shows a flowchart for security mechanism selection.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the base station at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The base station or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

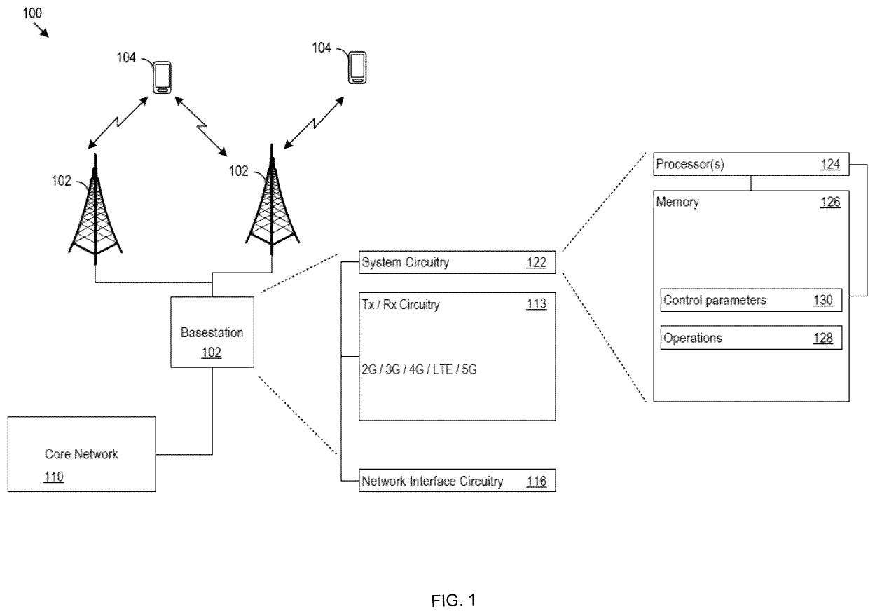

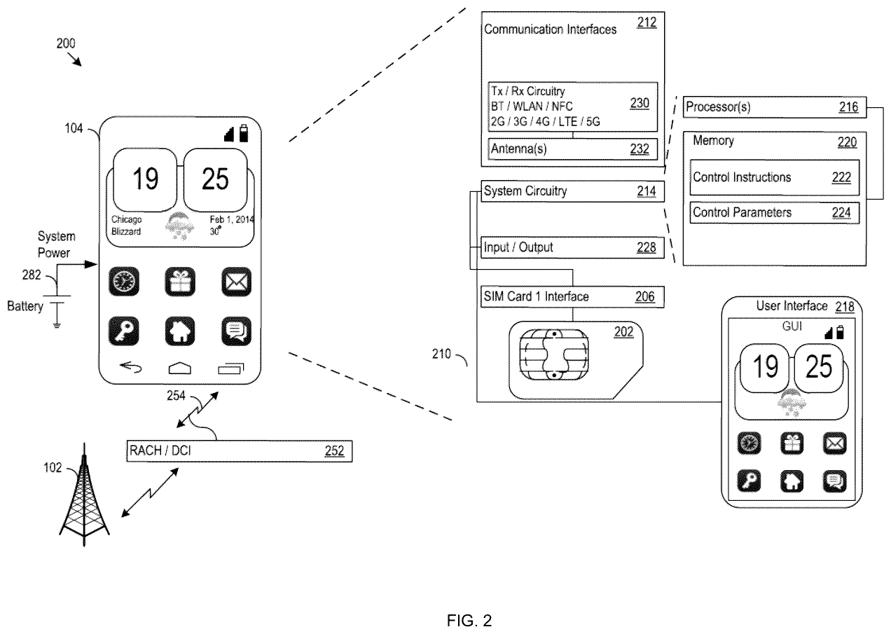

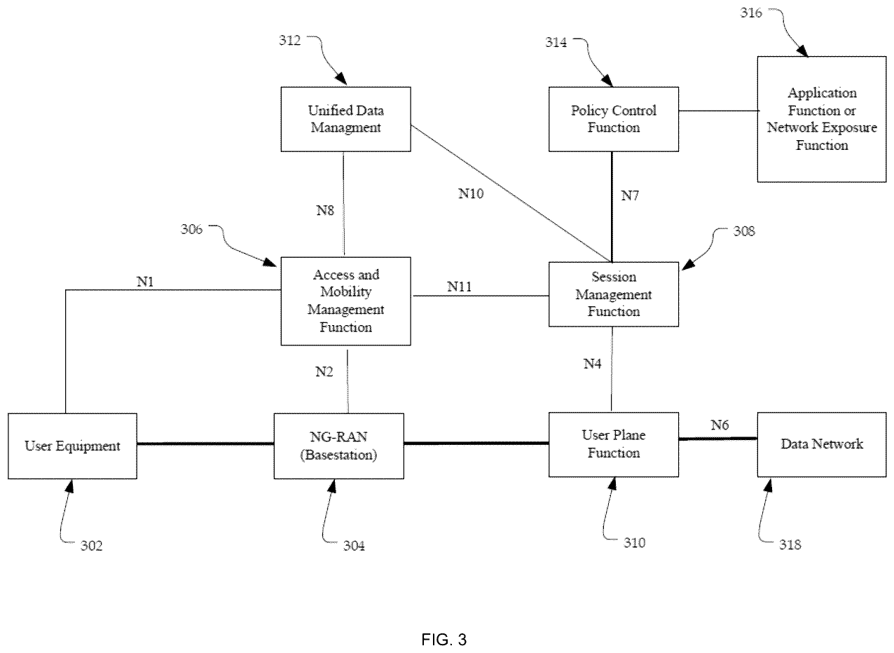

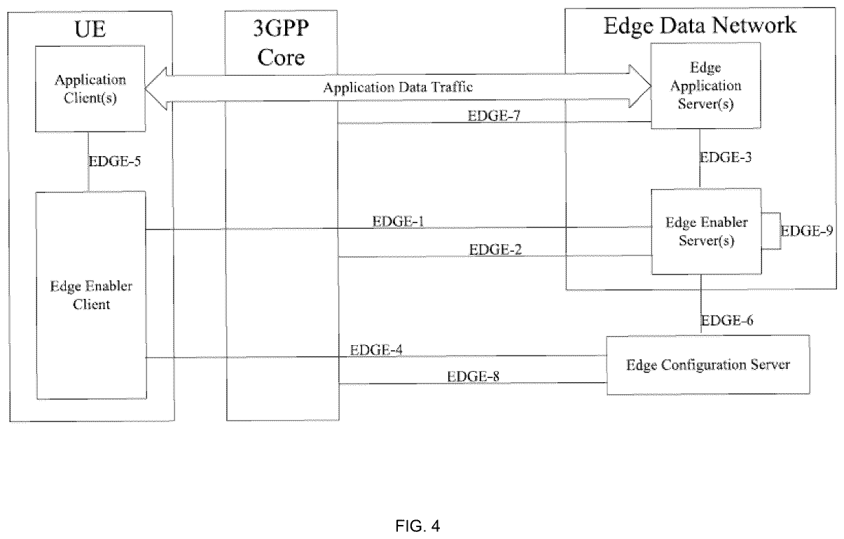

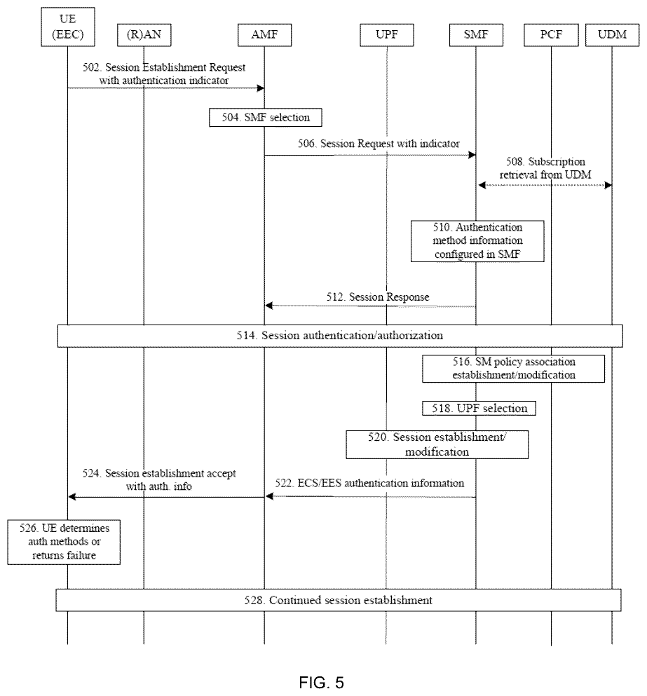

The Radio Access Network (RAN) may be a part of a wireless communication system that connects UE devices to other parts of a network through radio or wireless connections. FIG. 1 illustrates an example NG-RAN or base station. FIG. 2 illustrates an example random access messaging environment. FIGS. 3-4 illustrate an example architecture for edge architecture and security selection. FIGS. 5-9 illustrate wireless communication examples for the security selection.

There may be multiple authentication methods (e.g. Transport Layer Security (TLS)) between an Edge Enabler Client (EEC) and an Edge Configuration Server (ECS), or EEC and Edge Enabler Server (EES). As described, there may be security mechanism selection between EEC and ECS/EES. During the PDU session establishment procedure, UE that hosts EEC(s) receives ECS/EES authentication information (e.g. via Protocol Configuration Option (PCO)) and determines which to use. The ECS/EES authentication method information may include the authentication methods supported by ECS/EES and is included in protocol configuration option (PCO) information. During the PDU session establishment procedure, the UE that hosts EEC(s) receives ECS/EES authentication information via PCO and determines which to use. The SMF may not be aware of the internal structure of the authentication method information of EEC/EES.

FIG. 1 shows an example base station 102. The base station 102 may also be referred to as a wireless network node or a next generation radio access network (“NG-RAN”) node. The base station 102 may be further identified to as a nodeB (NB, e.g., an eNB or gNB) in a mobile telecommunications context. The example base station may include radio Tx/Rx circuitry 113 to receive and transmit with user equipment (UE) 104. The base station may also include network interface circuitry 116 to couple the base station to the core network 110, e.g., optical or wireline interconnects, Ethernet, and/or other data transmission mediums/protocols.

The base station may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the base station. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

FIG. 2 shows an example random access messaging environment 200. In the random access messaging environment a UE 104 may communicate with a base station 102 over a random access channel 252. In this example, the UE 104 supports one or more Subscriber Identity Modules (SIMs), such as the SIM1 202. Electrical and physical interface 206 (also referred as to a SIM card1 interface) connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 (also referred as to a system circuitry) may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs/outputs 228 may include a graphical user interface, touch sensitive display, haptic feedback or other haptic output, voice or facial recognition inputs, buttons, switches, speakers and other user interface elements. Additional examples of the inputs/outputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

FIG. 3 shows one embodiment of a wireless network system architecture. This architecture is merely one example and there may be more or fewer components for implementing the embodiments described herein. The interconnections or communications between components are identified as N1, N2, N4, N6, N7, N8, N10, and N11, which may be referred to in the description or by other Figures. FIG. 2 illustrated an example user equipment (“UE”) 104. UE 302 is a device accessing a wireless network (e.g. 5GS) and obtaining service via a NG-RAN node or base station 304. The UE 302 interacts with an Access and Mobility Management Function (“AMF”) 306 of the core network via NAS signaling. FIG. 1 illustrates an example base station 102 or NG-RAN 304. The NG-RAN 304 is responsible for the air interface resource scheduling and air interface connection management of the network to which the UE accesses. The AMF 306 includes the following functionalities: Registration management, Connection management, Reachability management and Mobility Management. The AMF 306 also performs the access authentication and access authorization. The AMF 306 is the NAS security termination and relay the session management NAS between the UE 302 and the SMF 308, etc.

The SMF 308 includes the following functionalities: Session Management e.g. Session establishment, modify and release, UE IP address allocation & management (including optional Authorization), Selection and control of uplink function, downlink data notification, etc. The user plane function (“UPF”) 310 includes the following functionalities: Anchor point for Intra-/Inter-RAT mobility, Packet routing & forwarding, Traffic usage reporting, QoS handling for user plane, downlink packet buffering and downlink data notification triggering, etc. The Unified Data Management (“UDM”) 312 manages the subscription profile for the UEs. The subscription includes the data used for mobility management (e.g. restricted area), session management (e.g. QoS profile). The subscription data also includes slice selection parameters, which are used for AMF 306 to select a proper SMF 308. The AMF 306 and SMF 308 get the subscription from the UDM 312. The subscription data may be stored in a Unified Data Repository with the UDM 312, which uses such data upon reception of request from AMF 306 or SMF 308. The Policy Control Function (“PCF”) 314 includes the following functionality: supporting unified policy framework to govern network behavior, providing policy rules to control plane function(s) to enforce the policy rule, and implementing a front end to access subscription information relevant for policy decisions in the User Data Repository. The Network Exposure Function (“NEF”) 316 is deployed optionally for exchanging information with an external third party. In one embodiment, an Application Function (“AF”) 316 may store the application information in the Unified Data Repository via NEF. The UPF 310 communicates with the data network 318.

FIG. 4 shows an embodiment of a wireless network system architecture for enabling edge applications. The EDN (Edge Data Network) may be a local Data Network. The EAS(s) (Edge Application Server) and the EES are included within the EDN. The ECS provides configurations related to the EES, including details of the EDN hosting the EES. The UE contains AC(s) (Application Client) and the EEC. The EAS(s), the EES and the ECS may interact with the 3GPP Core Network. For authentication between EEC and ECS, TLS authentication methods may be used. The TLS authentication methods may include client certificate, AKMA, and/or GBA. If the EEC sends the GPSI to the ECS, then the ECS shall also authenticate the GPSI. For authentication between EEC and EES, TLS authentication methods may be used.

FIG. 5 shows an embodiment for security mechanism selection with local breakout. This security mechanism selection is between EEC and ECS/EES for non-roaming and roaming with local breakout. The roaming architectures may specify local breakout, which is when UE and SMF are in the same area. This local breakout may allow for applications receiving locally rather than from a home network. In block 502, a user equipment (UE) that hosts EEC(s) may indicate in an authentication indicator that it supports the ability to receive ECS/EES authentication information. The authentication information may be via NAS. Further, the support may include the ability to transfer the ECS/EES authentication information to the EEC(s). In one example, the authentication indicator may be a Protocol Configuration Option (PCO).

The establishment process (e.g. PDU Establishment) further includes the AMF selects the SMF in block 504. In block 506, the AMF sends a session request message (e.g. a Nsmf_PDUSession_CreateSMContext Request) to the SMF that includes the authentication indicator. The indicator (e.g. PCO) indicates the ability to receive ECS/EES authentication information is included in the request message. In one example, this may be in the N1 SM container. In block 508, the SMF may receive ECS/EES authentication method information from the UDM together with SM subscription information. In one embodiment, the ECS/EES authentication method information may be provided to SMF as Session Management Subscription data. The retrieval in block 508 is one option for receiving the authentication information, while block 510 includes another option. In block 510, ECS/EES authentication method information may be pre-configured in SMF. In local breakout examples, the information is pre-configured in V-SMF and/or preconfigured in the SMF itself.

In block 512, the SMF sends a session response. The session response may include a Nsmf_PDUSession_CreateSMContext Response. The session response may be sent to the AMF to indicate the result of session establishment. In some embodiments, there may be an optional secondary authentication/authorization in block 514.

In block 516, the SMF performs PCF selection, and/or performs an SM Policy Association Establishment procedure. The SMF may decide to send updated ECS/EES authentication information to the UE based on locally configured policy or based on updated UE subscription information. The session modification procedure (e.g. PDU Session Modification) is used to send updated ECS/EES authentication information to the UE. In one example, the supported authentication methods may be changed or the priority of supported authentication methods list may be changed. In block 518, the SMF performs UPF selection. In block 520, the SMF initiates a session establishment or session modification (e.g. an N4 Session Establishment or modification procedure) with the selected UPF. In block 522, the SMF sends authentication information in a message (e.g. Namf_Communication_N1N2MesssageTransfer) to the AMF. If the UE indicated in the authentication indicator that it supports the ability to receive ECS/EES authentication information via NAS, then the ECS/EES authentication information is blocks 508 or 510, or it may be updated from block 516. This may be provided to the UE (e.g. via PCO which is included in an N1 container).

In block 524, a session establishment acceptance message (e.g. PDU Session Establishment Accept) is sent. The AMF provides an N1 SM container which contains the session establishment acceptance message to the UE. The message may include the authentication information. In block 526, the authentication information received from SMF is used by the UE for selecting authentication methods. For example the UE selects TLS authentication methods supported by both EEC and ECS/EES. It may also be used for the authentication between EEC and ECS/EES. If there are no authentication methods supported by both, then the UE returns a failure message. In block 528, the session establishment process is continued. Specifically, the steps of PDU session establishment procedure are continued.

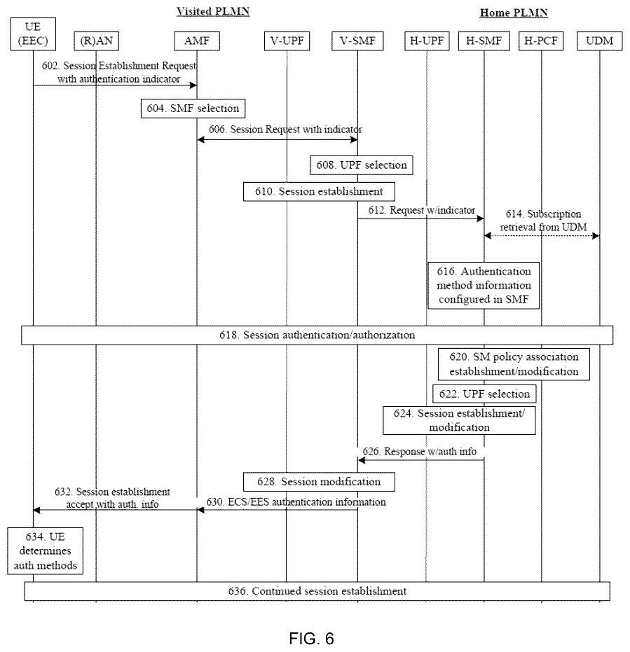

FIG. 6 shows an embodiment for security mechanism selection for home-routed roaming. As shown are components from the visitor or visited public land mobile network (PLMN) as well as a home PLMN. This visited components are identified with a prefix “V-” and the home components are identified with a prefix “H-”. FIG. 6 may include session establishment (e.g. PDU session establishment) in a home-routed roaming scenario in which at least some information is received from a home network. As discussed above, the security mechanism selection may be between EEC and ECS/EES for home-routed roaming. In block 602, a session establishment request is sent that includes an authentication indicator. The authentication indicator may be a PCO that identifies whether it supports the ability to receive ECS/EES authentication information via NAS and to transfer the ECS/EES authentication information to the EEC(s). A UE that hosts EEC(s) may include the indicator. In block 604, the AMF selects an SMF in the visited network. In block 606, the AMF sends a session request message (e.g. a Nsmf_PDUSession_CreateSMContext Request) to the V-SMF that includes the authentication indicator. The indicator (e.g. PCO) indicates the ability to receive ECS/EES authentication information is included in the request message. In one example, this may be in the N1 SM container and is sent to V-SMF. In block 608, the V-SMF performs UPF selection in the visited network. In block 610, the V-SMF initiates session establishment, which may include an N4 Session Establishment procedure with the selected V-UPF in one embodiment. In block 612, the request with the authentication indicator is sent from V-SMF to H-SMF. The request may be an Nsmf_PDUSession_Create Request to the H-SMF.

There are at least two embodiments for retrieval of authentication information. In block 614, the H-SMF may receive ECS/EES authentication information from the UDM together with SM subscription information. The authentication information may include types of authentication methods that are supported. The ECS/EES authentication method information is provided to SMF as Session Management Subscription data. In block 616, the authentication information may be configured in SMF in one embodiment. Specifically, ECS/EES authentication method information is pre-configured in H-SMF. In block 618, there may be an optional secondary authentication/authorization.

In block 620, a SM policy association establishment or modification. Specifically, the H-SMF performs PCF selection, and performs an SM Policy Association Establishment procedure. The SMF may decide to send updated ECS/EES authentication information to the UE based on locally configured policy or updated UE subscription information. The PDU Session Modification procedure may be used to send updated ECS/EES authentication information to the UE. For example, the supported authentication methods may be changed or the priority of supported authentication methods list may be changed. In block 622, H-SMF performs UPF selection in the home network. In block 624, a session establishment or modification may be performed. For example, it may include an N4 Session Establishment is performed in the home network. In block 626, a response with the authorization information may be provided. For example, H-SMF sends Nsmf_PDUSession_Create Response to V-SMF. The response may include authorization information (e.g. PCO) that may be ECS/EES authentication information. In block 628, there may be a session modification. Specifically, the V-SMF initiates an N4 Session Modification procedure with the V-UPF.

In block 630, the authentication information may be included in a message to the AMF. Specifically, the message may be sent by the V-SMF and may be a Namf_Communication_N1N2Message Transfer message that is sent to AMF. If the UE indicated in the authentication indicator that it supports the ability to receive ECS/EES authentication information via NAS, the ECS/EES authentication information is received in block 614 or 616, or is updated from block 620 where it will be provided to UE. In on example, it is provided via PCO which is included in an N1 container. In block 632, the session establishment acceptance message is provided that includes the authentication information. AMF provides the N1 SM container which contains the PDU Session Establishment Accept message to the UE. The authentication information may be PCO, which is included in the message. In block 634, the UE determines authentication methods based on the authentication information. According to the ECS/EES authentication information received from H-SMF (e.g. via PCO), the UE selects transport layer security (TLS) authentication methods that are both supported by EEC and ECS/EES. And it can be used for the authentication between EEC and ECS/EES. If there are no authentication methods supported by both sides, it returns failure. In block 636, the session establishment procedure continues.

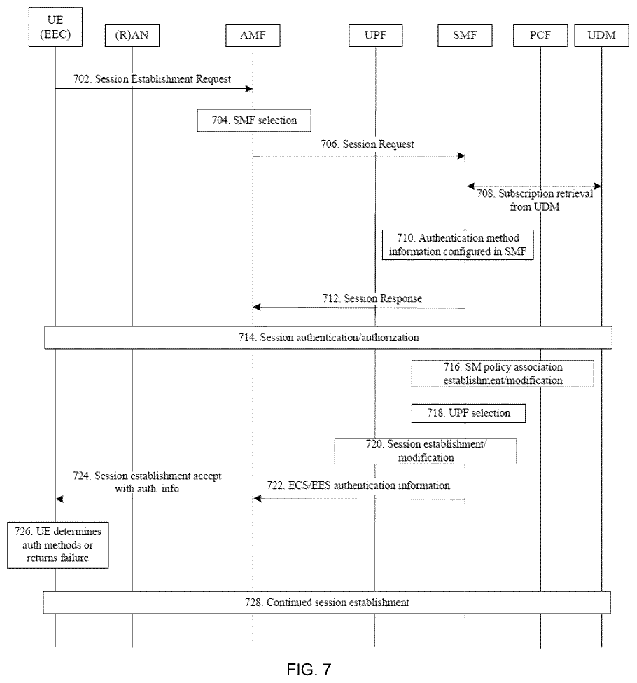

FIG. 7 shows another embodiment for security mechanism selection with local breakout. FIG. 7 specifies PDU Session establishment in the non-roaming and roaming with local breakout cases. In this embodiment, the authentication indicator is not included in the establishment request. If the network supports Edge Computing, then SMF or UDM has authentication information to be sent when the authentication information is stored in SMF or UDM. The roaming architectures may specify local breakout, which is when UE and SMF are in the same area. This local breakout may allow for applications receiving locally rather than from a home network. In block 702, there is a session establishment request. In this embodiment, there may not be an authentication indictor transmitted with the request.

The establishment process (e.g. PDU Establishment) further includes the AMF selects the SMF in block 704. In block 706, the AMF sends a session request message (e.g. a Nsmf_PDUSession_CreateSMContext Request) to the SMF. In block 708, the SMF may receive ECS/EES authentication method information from the UDM together with SM subscription information. In one embodiment, the ECS/EES authentication method information may be provided to SMF as Session Management Subscription data. The retrieval in block 708 is one option for receiving the authentication information, while block 710 includes another option. In block 710, ECS/EES authentication method information may be pre-configured in SMF. In local breakout examples, the information is pre-configured in V-SMF and/or preconfigured in the SMF itself. As described, authentication information may include support from a user equipment (UE) that hosts EEC(s). The support may include the ability to transfer the ECS/EES authentication information to the EEC(s). In one example, the authentication information may be part of a Protocol Configuration Option (PCO).

In block 712, the SMF sends a session response. The session response may include a Nsmf_PDUSession_CreateSMContext Response. The session response may be sent to the AMF to indicate the result of session establishment. In some embodiments, there may be an optional secondary authentication/authorization in block 714. In block 716, the SMF performs PCF selection, and/or performs an SM Policy Association Establishment procedure. The SMF may decide to send updated ECS/EES authentication information to the UE based on locally configured policy or based on updated UE subscription information. The session modification procedure (e.g. PDU Session Modification) is used to send updated ECS/EES authentication information to the UE. In one example, the supported authentication methods may be changed or the priority of supported authentication methods list may be changed. In block 718, the SMF performs UPF selection. In block 720, the SMF initiates a session establishment or session modification (e.g. an N4 Session Establishment or modification procedure) with the selected UPF. In block 722, the SMF sends authentication information in a message (e.g. Namf_Communication_N1N2Message Transfer) to the AMF. If the UE indicated in the authentication indicator that it supports the ability to receive ECS/EES authentication information via NAS, then the ECS/EES authentication information is blocks 708 or 710, or it may be updated from block 716. This may be provided to the UE (e.g. via PCO which is included in an N1 container).

In block 724, a session establishment acceptance message (e.g. PDU Session Establishment Accept) is sent. The AMF provides an N1 SM container which contains the session establishment acceptance message to the UE. The message may include the authentication information. In block 726, the authentication information received from SMF is used by the UE for selecting authentication methods. For example the UE selects TLS authentication methods supported by both EEC and ECS/EES. It may also be used for the authentication between EEC and ECS/EES. If there are no authentication methods supported by both, then the UE returns a failure message. In one embodiment, this may be a determination as to whether the UE has MEC services, such as Edge Computing Services. If there is no support for edge computing, then it just ignores. If there is support, then it hosts EEC(S) and it selects TLS authentication methods both supported by EEC and ECS/EES. In block 728, the session establishment process is continued. Specifically, the steps of PDU session establishment procedure are continued.

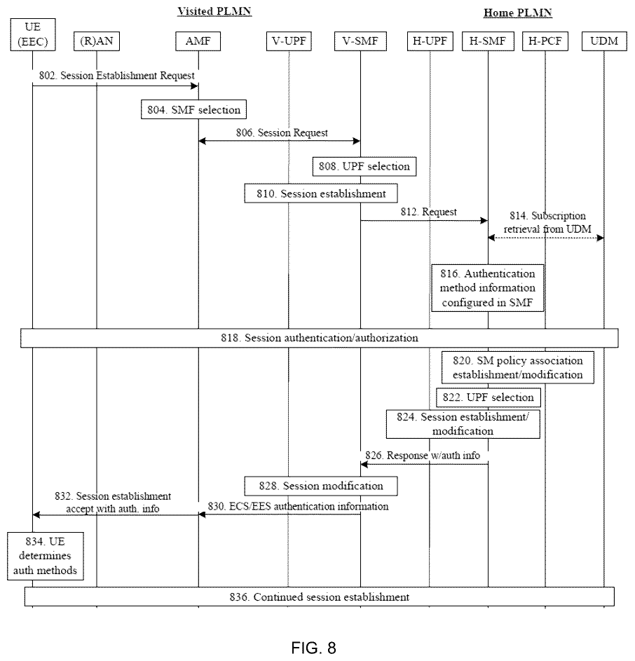

FIG. 8 shows another embodiment for security mechanism selection for home-routed roaming. As shown are components from the visitor or visited public land mobile network (PLMN) as well as a home PLMN. This visited components are identified with a prefix “V-” and the home components are identified with a prefix “H-”. FIG. 8 may include session establishment (e.g. PDU session establishment) in a home-routed roaming scenario in which at least some information is received from a home network. As discussed above, the security mechanism selection may be between EEC and ECS/EES for home-routed roaming. In block 802, a session establishment request is sent. In this embodiment, the request may not include an authentication indicator. In block 804, the AMF selects an SMF in the visited network. In block 806, the AMF sends a session request message (e.g. a Nsmf_PDUSession_CreateSMContext Request) to the V-SMF. In block 808, the V-SMF performs UPF selection in the visited network. In block 810, the V-SMF initiates session establishment, which may include an N4 Session Establishment procedure with the selected V-UPF in one embodiment. In block 812, the request is sent from V-SMF to H-SMF. The request may be an Nsmf_PDUSession_Create Request to the H-SMF.

There are at least two embodiments for retrieval of authentication information. In block 814, the H-SMF may receive ECS/EES authentication information from the UDM together with SM subscription information. The authentication information may include types of authentication methods that are supported. The ECS/EES authentication method information is provided to SMF as Session Management Subscription data. In block 816, the authentication information may be configured in SMF in one embodiment. Specifically, ECS/EES authentication method information is pre-configured in H-SMF. In block 818, there may be an optional secondary authentication/authorization.

In block 820, a SM policy association establishment or modification. Specifically, the H-SMF performs PCF selection, and performs an SM Policy Association Establishment procedure. The SMF may decide to send updated ECS/EES authentication information to the UE based on locally configured policy or updated UE subscription information. The PDU Session Modification procedure may be used to send updated ECS/EES authentication information to the UE. For example, the supported authentication methods may be changed or the priority of supported authentication methods list may be changed. In block 822, H-SMF performs UPF selection in the home network. In block 824, a session establishment or modification may be performed. For example, it may include an N4 Session Establishment is performed in the home network. In block 826, a response with the authorization information may be provided. For example, H-SMF sends Nsmf_PDUSession_Create Response to V-SMF. The response may include authorization information (e.g. PCO) that may be ECS/EES authentication information. In block 828, there may be a session modification. Specifically, the V-SMF initiates an N4 Session Modification procedure with the V-UPF.

In block 830, the authentication information may be included in a message to the AMF. Specifically, the message may be sent by the V-SMF and may be a Namf_Communication_N1N2Message Transfer message that is sent to AMF. If the UE indicated in the authentication indicator that it supports the ability to receive ECS/EES authentication information via NAS, the ECS/EES authentication information is received in block 814 or 816, or is updated from block 820 where it will be provided to UE. In on example, it is provided via PCO which is included in an N1 container. In block 832, the session establishment acceptance message is provided that includes the authentication information. AMF provides the N1 SM container which contains the PDU Session Establishment Accept message to the UE. The authentication information may be PCO, which is included in the message. In block 834, the UE determines authentication methods based on the authentication information. According to the ECS/EES authentication information received from H-SMF (e.g. via PCO), the UE selects transport layer security (TLS) authentication methods that are both supported by EEC and ECS/EES. And it can be used for the authentication between EEC and ECS/EES. If there are no authentication methods supported by both sides, it returns failure. In block 836, the session establishment procedure continues.

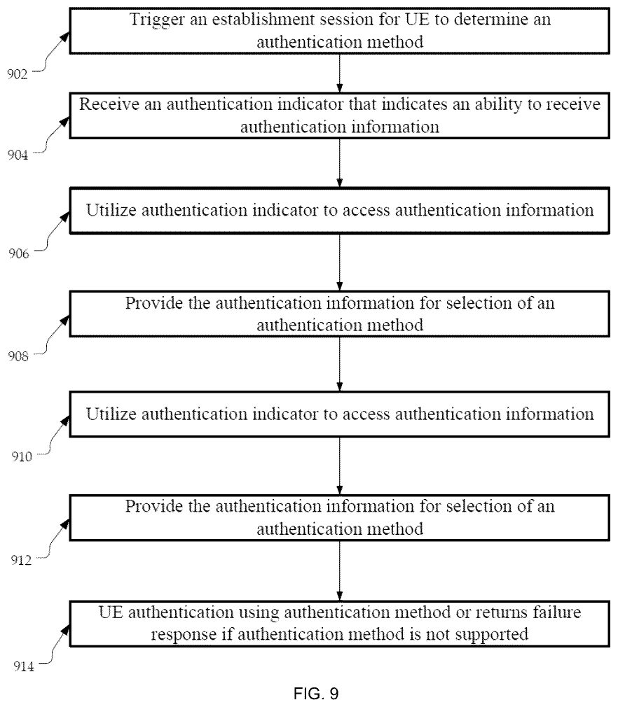

FIG. 9 shows a flowchart for security mechanism selection. In block 902, an establishment session, such as Packet Data Unit (PDU) establishment is triggered. The PDU establishment may include security mechanism selection. In block 904, an authentication indicator is received. The authentication indicator indicates an ability to receive authentication information, which may include an ability to support different authentication methods. In block 906, the authentication indicator is used to access the authentication information. In block 908, the authentication information is provided for the selection of one or more authentication methods. This selection may include a determination of support for a particular authentication method. In block 910, the authentication indicator is utilized to access the authentication information. In block 912, the authentication information is provided for selection of an authentication method, which may include a determination of support for the selected authentication method. In block 914, the UE authentication is performed using the selected authentication method, or a failure response is provided if the authentication method is not supported.

In an alternative embodiment, a third party application function (AF) may use a provision parameter (e.g. Nnef_ParameterProvision) to provide, update, or delete AF provided ECS/EES authentication method information. Specifically, the AF may use the provision parameter to send a new AF provided ECS/EES authentication method information to the UDM. This may be based on Application layer activity or other activity. The UDM may notify the impacted SMF(s) of the updated Subscription provided ECS authentication methods information. The new ECS authentication methods information will be sent to the UE(s) in a session modification procedure (e.g. PDU Session Modification). In other words, the authentication information in the UDM can be updated by the message.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A wireless communication method comprising:
receiving an authentication indicator;
utilizing the authentication indicator to access authentication information; and
providing the authentication information for selecting an authentication method.

2. The method of claim 1, wherein the authentication indicator comprises an indication of an ability to receive the authentication information which comprises whether certain ones of a plurality of authentication methods are supported.

3. The method of claim 1, wherein the receiving the authentication indicator is during an establishment session.

4. The method of claim 1, wherein the providing is to a user equipment (UE) that determines the authentication method based on the provided authentication information.

5. The method of claim 4, wherein the authentication method is supported by Edge Configuration Server (ECS)/Edge Enabler Server (EES), further wherein the authentication information indicates the authentication method supported by ECS/EES that is used by the UE to determine authentication method support.

6. The method of claim 4, wherein a Session Management Function (SMF) receives the authentication information.

7. The method of claim 4, wherein a Session Management Function (SMF) has preconfigured the authentication information.

8. The method of claim 1, wherein the wireless communication method is for session establishment with local breakout and also in a non-roaming scenario.

9. The method of claim 1, wherein the wireless communication method is for session establishment with home routed roaming.

10. The method of claim 9, wherein the indicator authentication and the authentication information is transmitted between a visited network and a home network.

11. A wireless communication method comprising:
transmitting an authentication indicator, wherein the authentication indicator is used to access authentication information;
receiving the authentication information; and
selecting an authentication method based on the authentication information.

12. The method of claim 11, wherein the authentication indicator comprises an indication of an ability to receive the authentication information, or
the authentication information comprises whether certain ones of a plurality of authentication methods are supported.

13. The method of claim 11, wherein the transmitting, the receiving, and the selecting is by a user equipment (UE) and the accessing of the authentication information is by a network.

14. The method of claim 13, wherein the authentication method is supported by Edge Configuration Server (ECS)/Edge Enabler Server (EES), further wherein the authentication information indicates the authentication method supported by ECS/EES that is used by the UE to determine authentication method support.

15. The method of claim 11, further comprising:
providing, from a user equipment (UE), a determination of the authentication method supported by the received authentication information; and
returning a failure response when the authentication information indicates that the authentication method is not supported.

16. A wireless communication method comprising:
accessing authentication information comprising an indication of an ability to support edge computing services; and
providing the authentication information for selecting an authentication method.

17. The method of claim 16, wherein the providing is to a user equipment (UE) that determines the authentication method based on the provided authentication information.

18. The method of claim 17, wherein the UE returns a failure response if the authentication information indicates that a particular authentication method is not supported.

19. The method of claim 17, wherein the authentication method is supported by Edge Configuration Server (ECS)/Edge Enabler Server (EES), further wherein the authentication information indicates the authentication method supported by ECS/EES that is used by the UE to determine authentication method support.

20. A wireless communications apparatus comprising a processor and a memory, wherein the processor is configured to read code from the memory and implement a method recited in claim 1.
